(19) United States
(12) Patent Application Publication
(10) Pub. No.: US 2013/0086884 A1
(43) Pub. Date: Apr. 11, 2013

(54) Unknown

(71) Applicant: Diana Michaels-Christopher, Sofia (BG)

(72) Inventor: Van Michaels-Christopher, Sofia (BG)

(21) Appl. No.: 13/437,028

(22) Filed: Apr. 2, 2012

Related U.S. Application Data
(63) Continuation-in-part of application No. 12/214,840, filed on Jun. 24, 2008, now abandoned.

(51) Int. Cl. F02C 3/20

(52) U.S. Cl. CPC F02C 3/20
USPC 60/200.1; 290/1 A; 44/437; 423/648.1

(57) ABSTRACT

Whereby the spiral channels of the bladeless rotor and stator of the Bezentropic Bladeless Turbine are attached to the Laval nozzle, as well as to any preferred modification of the same nozzle, act as an extension of nozzle's divergent end, transforming it into a Bezentropic Bladeless Turbine, all the while retaining the nozzle's efficiency and efficacy, achieved as a result of the maintenance and sustenance of the mono-directional rectified molecular flow of gas, steam or its combination thereof, emitted by the nozzles into the Bezentropic Bladeless Turbines spiral channels to produce mechanical work or thrust.

This application is a Continuation-In-Part of application Ser. No. 12/214,840, filed on Jun. 24, 2008 with a Confirmation Number 3673, the entire disclosure of which is hereby incorporated by reference. The art and novelty of this invention, its disclosure and subsequent claims, is based on the use of two processes and the devices that enable them to produce mechanical work or thrust based on the preferred energy sources used. The first process involves the new use of rectified, mono directional jet stream of gas, steam, or of both, to produce mechanical work or thrust, instead of the conventional use of kinetically disordered molecules of gas, steam, or of both, for the production of work or thrust. The second process enables the use of this molecular rectification, through maintenance and sustenance of the rectification process, by impeding its reversal into kinetic disorder, for the aforementioned production of mechanical work or thrust. Consequently, a series of devices were developed in order to achieve these two processes and desired effects. This new use of the molecular rectification, attained when the kinetically disordered gas, steam, or a combination of both, is injected into the convergent end of nozzle of Laval, or of the oval (flat) nozzle of this inventor, which, when emerging in a mono-directional rectified supersonic jet stream from the divergent end of either nozzle, centers on the principle that it is used in this rectified condition, rather then reconverting it into its original kinetic disorder, to produce work or thrust. Whereas, the originality of the second process, which enables the use of this rectified molecular order to produce mechanical work or thrust, centers on its ability to maintain and sustain it, thereby impeding the gas, steam or the combination of both from reverting to their original kinetic disorder. This maintenance and sustenance of the rectified, mono-directional molecular order is attained when the emergent rectified molecules emitted at the divergent end of either the nozzles, are injected into the spiral channels of the Bladeless Bezentropic Turbine, the device that maintains and sustains this process and disclosed herein, resulting in co-linear, cyclic or vortex (circular) supersonic jet stream of rectified molecules of steam, gas, or a combination of both, and used as the working body for the production of mechanical work or thrust. Therefore, the novelty and usefulness of this invention is threefold. First, it has identified and put to a new use the stimulated rectification process and its application for the production of mechanical work or thrust instead of reconverting it into kinetic disorder and using this disorder to produce work. Secondly, it develops a process whereby the molecular rectification is maintained and sustained, via the devices disclosed herein, using it as the working body to produce mechanical work or thrust, without the molecules reconverting into their original kinetic disorder. Third, the novelty and usefulness of this invention and its modifications, pertains to the devices developed for attaining and maintaining the efficiency and efficacy of the Laval nozzle, the oval (flat) nozzle of this inventor or of other modified nozzles, through the extension of their divergent end attained through the attachment of the spiral channels devised by this inventor and disclosed herein, resulting in extremely efficient turbines, with minimized entropic losses when attached to combustion chambers, compressor, or preferred steam generator and using a series of preferred energy sources. These devices have been named Bezentropic to underscore their use of the rectification process and of its maintenance and sustenance in order to distinguish and differentiate them from their classic turbine counterparts, possessed of multitudes of blades, and of their use of the kinetically disordered gas or steam for their working body, incurring entropic losses. The Bezentropic Bladeless turbine has been built and tested at the Radomir Metals Inc. plant, located in Radormir, Bulgaria.

### BACKGROUND OF THE INVENTION

The use of the process of molecular rectification, and the process of its maintenance and sustenance, for mechanical work or thrust, is based on a reconsideration of the classic works of Carnot, James Maxwell, Ludwig Boltzmann, Max Plank and M. Smoluhovsky. Ludwig Boltzmann's observation of entropy, as being a statistical phenomenon of kinetically disordered gas molecules invalid for micro quantities, led the author of this invention to entertain the idea and the exploration of the alternate state of gas, namely, its rectified, molecularly ordered status. Secondly, the research focused on developing the means of maintaining and sustaining this process so that it could be practically and successfully used in the production of mechanical work or thrust.

This led the inventor to the exploration of the properties and effects produced by the Nozzle of Laval and Bernoulli's equation, by exploring its properties through the equations for: momentum; velocity; relationship between pressure and velocity, time independent flow; the relationship between entropy, enthalpy, and pressure, the adiabatic flow along a stream line and its use; the mass flux density. Landau and Lifshitz have explored this in detail in their Fluid Mechanics, as well as the tests conducted by researchers at the Max Plank Institute see FIGS. 2(a) and 2(b). There it is shown that under pressure, the velocity of the gas emerging from the divergent end of nozzle of Laval, emerges rectified and mono-directional, is substantially higher then the speed of the sound as shown by Bernoulli's formula:

$$\frac{1}{2} V = \frac{{C}_{o}^{2}}{y - 1} V = \frac{{( 2 )}^{\frac{1}{2}}}{y - 1} Co$$

As “y” is greater than zero (Poisson's constant) the “y” propagates with supersonic speed. However, the nozzle of Laval by itself, and when used with the classic turbines, is neither a particularly useful nor a very efficient device. The reason for this inefficiency is due to the fact that although the nozzle of Laval can emit a supersonic jet stream of rectified or mono directed gas molecules, once this jet stream is injected into the classic turbines, nothing maintains and sustains their initial rectified order, and with the jet flow's very first encounter of their blades, these rectified, mono directional gas molecules revert to their original kinetically disordered state, resulting in entropic losses. Then with the encounter of each successive blade, regardless of the refinement to its design, this kinetically disordered gas flow is subjected to subsequent entropic losses, significantly reducing the classic turbines' efficiency.

Next the inventor explored the properties of the Archimedean spirals, as a means of entirely restructuring the classic turbines. The definition of the Archimedean spirals being: “a curve, the locus of a point that moves outward with uniform speed along a vector, beginning at the origin, while the vector rotates about the origin with uniform angular velocity”. This research was extremely useful when devising the processes and devices disclosed herein.

### THE INVENTION

The main object of this invention is the introduction and new use of the process of stimulated molecular rectification of gas, steam, or a combination of the two, directly and without reconverting into kinetic disorder, in the production of mechanical work or thrust. The second object of this invention is the development of the process of maintenance and sustenance of this molecularly rectified order, by preventing it from disintegrating into kinetic molecular disorder, thereby enabling it for practical use. As a result, the inventor termed these two processes “Besentropic”, indicating the use of rectified molecular jet flow of steam, gas or a combination of both, and its sustenance and maintenance. As such, the spiral channels which enable this maintenance and sustenance of the rectified molecular jet flow or stream, providing for unimpeded propagation of the said supersonic rectified molecular jet stream, were devised, in order to attain the desired mechanical work or thrust, forming a part of the Bezentropic Bladeless Turbine and its variations like the Universal Bezentropic Steam Turbine, the Bezentropic Wind Turbine, the Bezentropic hydraulic Freon Turbine, and the Bezentropic Turbo Compressor. The modification of these devices is based on the preferred alternative source of energy used, providing non-pollutant alternatives beyond wind power. As stated in the foregoing, the term Bezentropic has been used to designate the fact that these devices use molecular rectification, an adiabatic process with direct heat to work conversion, maintained and sustained, to produce mechanical work or thrust, whereby distinguishing them from the conventional devices which use disordered kinetic gas molecules relying on volume expansion to produce mechanical work.

To this end, the inventor identified and isolated the elements which the device had to possess in order to attain the desired processes: a choice of nozzles, preferably of Laval, emitting rectified molecular stream of gas, steam or of a combination of both; or developing a nozzle whose divergent end would fit more readily into the device that would replicate the property of the Archimedean spirals, yet maintain and sustain the aforementioned rectification, namely the spiral channels. These channels had to provide unobstructed pathway for the rectified mono-directional molecular jet stream to flow, maintain and sustain its velocity until spent in the production of mechanical work or thrust, with minimal entropic losses. To this end the spiral channels became a vital element of the searched for device. Consequently, this resulted in attaching the nozzle of Laval, or the oval (flat) nozzle of the inventor, to the stator of the rotor possessed of the spiral channels, which when the disordered molecular gas, steam or a combination of both, are injected into either nozzles, the emitted jet stream of molecularly rectified gas, steam (or a combination of both) enters tangentially into the spiral channels, evolving into directed co-linear, cyclic or circular (vortex) kinetic energy, which velocity and rectification is maintained and sustained until it is spent, thereby creating mechanical work or thrust. Calculations have indicated that the combination of the stimulated rectification process using either of the nozzles and when attached to the stator of the spiral channels forming the rotor, ensues in the maintenance and sustenance of the initial rectified mono direction jet stream, thereby creating devices with extreme efficiency. In essence the spiral channels form the mechanical extension of the divergent end of classic nozzle of Laval or its modifications, thereby transforming the nozzle into a turbine, all the while retaining the Nozzle's efficiency. With the addition of combustion chambers, compressor, or steam boiler, this Bezentropic Turbine, becomes and power plant which retains the efficiency of the Nozzle of Laval.

In The Accompanied Drawings,

FIG. 1(a) represents the bladeless Stator of the Bezentropic Turbine.

FIG. 1(b) represents the Rotor of the Bezentropic Bladeless turbine and its Spiral channels.

FIG. 1(c) represents, the oval (flat) nozzle, which blows its supersonic jet stream inside the rotor's spiral channels.

FIG. 1(d) represents the combustion chambers for the turbine.

FIG. 1(e)displays the insertion of the rotor inside the stator of the turbine.

FIG. 1(f) displays the Bezentropic Bladeless Turbine with the Bezentropic Turbo Compressor, oval nozzles and combustion chambers.

FIG. 1(g) displays the left and right disk to which the sheet metal spirals of the bladeless rotor are attached, forming the spiral channels.

FIG. 2(a) represents the steam jet table for the Nozzle of Laval for steam jets with parameters P, V, t, and W(velocity) along the nozzle.

FIG. 2(b) represents the nozzle of Laval.

FIG. 3. Depicts a Bezentropic Wind Turbine.

FIG. 4 Shows the Bezentropic Hydraulic Freon Turbine.

FIG. 5 Shows the production of safety Hydrogen as an alternative energy source for the Bezentropic

The art and novelty of the invention is threefold. Its first novelty pertains to the identification, introduction and finding a practical use of stimulated rectification of molecules of gas, steam or a combination of both, instead of the conventional use of kinetically disordered molecules of gas or steam for the production of work or thrust. This novelty is vitally important, in that the entropic losses incurred with the traditional turbines employing kinetically disordered gas or steam molecules can be significantly reduced. This process begins with the injection of gas, steam or both, into the convergent end of the selected nozzles, of Laval, of the oval (flat) nozzle of this inventor, or of other modified nozzles, which then undergoes the process described by Bernoulli's formula, with the emergent rectified supersonic jet stream of mono-directional molecules, are then injected into the Bezentropic bladeless turbine's spiral channels, forming the Bladeless Rotor, which maintains their co-linear, cyclic, or circular (vortex) order, where the mechanical forms of the molecular energies produce mechanical molecular jets, porters of linear and circular (vortex) kinetic energy, whose adiabatic nature yields spontaneous heat into work conversion. This adiabatic process, of spontaneous heat to work conversion, when desired, can convert the heat into potential or vortex energies, and when further desired converted it once again into work.

The second novelty of this invention centers on the provision of sustaining and maintaining this rectified kinetic molecular order emerging from the divergent end of the selected nozzles, without impeding its velocity and reducing the entropic loss to an absolute minimum. The afore mentioned spiral channels, form the necessary pathways for the rectified supersonic molecular jet stream to flow, whence attached to a shaft, together they form the Bezentropic Bladeless Rotor, which maintains and sustains the aforementioned molecular order, enabling the production of mechanical work or thrust. Consequently, the Bezentropic Bladeless Turbine, and its variations were developed, based on the preferred mode of energy used. This rectified molecular order, until its full conversion to work, is maintained and sustained by the Bezentropic bladeless rotor shown on FIG. 1(b).

The third novelty pertains to the effect of efficiency and efficacy with this new application of the nozzle of Laval, or of the oval (flat) nozzle of this inventor, or of any preferred nozzle modification, which when attached to the Bezentropic Bladeless Stator, and connected to Bezentropic Bladeless Rotor's spiral channels, results in the mechanical extension of the divergent end of the preferred nozzles, all the while retaining their capacities and efficiency. In essence, this creates out of the classic nozzle of Laval, the inventor's own oval (flat) nozzle, or of any nozzle modifications, a Bezentropic Bladeless turbine, by virtue of providing an extension of their divergent end, This is indeed a significant, novel, effective and efficient device extremely useful in the production of electrical power generation when attached to combustion chambers and compressor, or steam generator, or for generating thrust.

The Bezentropic Bladeless Turbine designed to meet the efficiency and efficacy requirements as set forth in the foregoing can be modified in accordance with the preferred energy sources used to power it. As such, it can be modified to work as a Universal Steam Turbine using a steam generator. With yet another modification, where the use of Freon steam is preferred, the Bezentropic Bladeless Turbine can be further modified to use Freon boilers, instead of the classic steam generator transforming it into a Bezentropic Hydraulic Freon Turbine using Freon precipitations as its energy source. Or it could be modified into a Bezentropic Wind Turbine, using wind power. The Bezentropic Turbine's combustion chambers can use safety hydrogen or non-pollutant fuel alloys, disclosed herein as a preferred alternative energy source.

The Bezentropic Bladeless Turbine

The essential components of the Bezentropic Bladeless Turbine are as follows: a bladeless Bezentropic stator (shown on FIG. 1(a)) housing a bladeless Bezentropic rotor, (shown on FIG. 1(b)) were devised, and further disclosed in this application. It uses a choice of nozzles, like the Laval or the oval (flat) nozzle shown on FIG. 1(c). The combustion chambers shown on FIG. 1(d) are standard; a choice of either a classic compressor or the bladeless Bezentropic Turbo Compressor shown on FIG. 1(e), and on 1(f), form the main components of the Bezentropic BladelessTurbine, shown on FIG. 1(f) intended for use in power plants to produce electricity.

The Bezentropic Stator, as seen on FIG. 1(a) is bladeless. It represents an empty horizontal cylinder with the necessary apertures, whose purpose is to house the bladeless Rotor of FIG. 1(b). Either nozzles of Laval or oval (flat) nozzles, as shown on FIG. 1(f) are affixed at the opposing at 180 degrees, onto the stator, shown separately on FIGS. 1(c) and (d). The said two nozzles are fed with pressured combusted gas from the combustion chambers, connected to the nozzles shown on FIG. 1(f) and separately on FIGS. 1(e) and (d). Selected Apertures are made for the spent gas to be removed for co-generation.

The Bezentropic Bladeless Rotor, like the aforementioned Bladeless Stator, as its name suggests, is bladeless as well. It has been designed thus in order to avoid the destruction of the rectified, co-linear, cyclic or circular (vortex) molecular order of the supersonic jets, emitted from nozzles. The purpose of the nozzles is to rectify the kinetically disordered molecular flow emitted by the combustion chambers or steam generator, then to accelerate the jets to supersonic velocity, injecting this stream into the spiral channels of the bladeless Rotor. The role of the spiral channels, attached to the shaft of the Rotor is to maintain the obtained molecular order and to sustain it until the full conversion of the linear kinetic energy into spiral circular kinetic energy takes place, using it as the working body, in attaining mechanical work or thrust. In order to achieve this task, the thousands of blades found in the classic rotors, are replaced by two or more opposing, evolving, sheet spirals, that arc attached at either end to a disk FIG. 1(g), and wound around a shaft, thereby the space between the sheet spirals creates two or more opposing spiral channels. The roles of the spiral channels is to maintain the molecular order of the Jet stream, by converting its kinetic energy, from linear into spiral, until the full conversion of this kinetic energy into work takes place. For this purpose, the nozzles' jets blow their kinetic energy tangentially to the rotor's spiral channels, while the exhausted working body (gas, steam, or a combination thereof) is exhausted centrally, through the circular series of apertures made around the sides of the turbine's shaft, and can be captured for co-generation.

The oval (flat) nozzle, developed by this inventor, and given on FIG. 1(c), consists of three main parts. Parts I, II, and III, which work as follows. Like the nozzle of Laval, Part I is convergent, while Part II is divergent (of the same 7 to 12 angular degrees) in order to permit the supersonic velocity acceleration as in the nozzle of Laval. The difference however, is found in the cross sections of Parts I and II, in that they are not circular, but are instead flattened to ovals, to correspond better to the rotor's spiral channels' cross sections, where the molecular Jets supersonically accelerated working body is injected. Up to this point, the flattened nozzle is expected to be a little bit less efficient than the round nozzle of Laval. In order to avoid this inconvenience, the inventor introduced a third mode of acceleration, which is performed by the dead ended tube III, affixed parallel to the output of the nozzle and perforated along its length, by a series of tiny holes. The role of the said perforation is to sprinkle preheated water steam. Once sprinkled, this water steam spontaneously flashes into saturated steam, increasing its volume over 1600 times, which additionally accelerates the velocity of the rectified molecular jets to over four times that of sound.

The Bezentropic Turbo Compressor

FIG. 1(e) represents the Bezentropic Turbo Compressor which can be used with the Bezentropic Bladeless Turbine. Essentially, its elements are the same as those of the Bezentropic Bladeless Turbine's rotor and stator, except that its diameter size is larger, and that instead of having combustion chambers, it is connected through two (2) wide tubes to two nozzles of Laval, themselves connected to the two combustion chambers. The roles of the said two nozzles of Laval, is to create strong dynamic pressure, thus to act as a check valve counteracting the static pressure inside the combustion chambers.

The Bezentropic Universal Steam Turbine

It uses the Bezentropic Bladeless Stator which houses the Bezentropic Bladeless Rotor. This bladeless rotor however, has two or more spiral channels. It can use any choice of selected nozzle, for instance, the oval (flat) nozzle, described in the specification, or the nozzle of Laval, to connect the Bezentropic turbine with the steam ducts of its generators. A 20 to 30 atmospheric pressure is required when firing the steam generator in order for the aforementioned turbine to begin work. It can use classic steam generators, wind power, or the Freon steam generator disclosed further in the Bezentropic Hydraulic Freon Steam Turbine.

The Bezentropic Wind Turbine

FIG. 3 depicts the Bezentropic Wind Turbine, which resembles the Universal Bezentropic Steam Turbine, as it essentially has the same bladeless cylindrical stator housing a bladeless rotor, around which are wound two or more spiral sheets forming two or more spiral channels. When the wind is blown, captured by an extra large sac-like vessel, that is opened to the wind, and elevated 50 to 100 meters on a pole-like tubular construction, whereby the wind flow is piped down via the tube, replacing the classic steam generator, thereby rotating the Bezentropic Bladeless turbine, which is then connected to a suitable electric generator.

Bezentropic Hydraulic Freon Steam Turbine

The capability of Freon to create a Freon steam generator is due to the fact that the new eco Freon has a boiling temperature in the order of −48 C to −50 C. Consequently, a temperature of only +50 C to +100 C is sufficient to produce the desired pressure of 20 to 30 atmospheres of preheated Freon steam. This is yet another modification of the Bezentropic Bladeless Turbine and its Universal Steam variation, and is displayed on FIG. 4. Like the Bezentropic Universal Steam Turbine, it has no combustion chamber. It comprises a closed circuit tubular system with a Freon boiler made of a tubular serpentine, which is heated by the hot end of a vortex tube, attached to a suitable compressor (Ab). Once the steam is heated it evaporates within the tube marked Fst, reaching the cooling element, the water cooler shown as (Wc) and connected to the tube marked H₂O which is optional, supplying it via the water tube Wp, and with air through tube Ap, as it serves to speed up the condensation, where the Freon steam is condensed. This in turn is cooled by the cold end of the vortex tube, then, the precipitation takes place resulting in a Freon falls, that turns the Bezentropic turbine's rotor, connected to a suitable compressor and a generator (EG). The potential energy that the latent heat of vaporization creates, requires a closed circuit tubular elevation of 100 to 200 meters, once reaching the cooling element where the Freon steam is condensed, the said potential energy is spontaneously converted in to kinetic energy as a result of the Freon precipitation (Fp), flowing down the closed circuit tube, reaching and rotating the Bezentropic Hydraulic Freon Turbine (Fht), (through the Freon tube, Fp,) thereby, rotating both the compressor, Ab, and the electric generator, EG. Like the classic waterfall hydraulic turbines, it works without fuel because, as it uses as its primary source of energy the latent heat of the Freon's vaporization, obtained from the heat of the atmospheric air, which is drawn in from the air blower, Ab. This process however, is more efficient and effective as Freon precipitation is about 18 times more quickly created, than the natural waterfalls, because its latent heat of vaporization is only in the order 32 Kcal/kg, while that of water (both at ambient temperature) is 600 Kcals/kg. This means that the Freon would make roughly 18 more cycles of evaporation, condensation and Feonfalls at ambient temperature, as opposed the water at its boiling temperature of 100 C.°. This is because, the allowed ecological Freons, boil, in the temperature range of −48° C. to −50° C., while water boils at 100° C. It is these parameters of the eco Freons, which makes them extremely attractive for the erection of Bezentropic hydraulic electrical power plants.

The New Art Of Manufacturing Safety (Quiet) Hydrogen

It consists of a treble plurality (set) of steps. The first one is a redox (Reduction)+Oxidation) obtained by modifying the reaction yielding sodium manganate Na2Mn0₄, a dark green rocky substance, by conducting it in the absence of air and adding to the reaction Talk (hydrated Magnesium silicate) 3MgO.4Si0₂.H₂O, to facilitate the following Hydrolysis of the thus obtained rocky Sodium Manganate. The hydrolysis reverts back the initial reactants, the Sodium hydroxide (NaOH) and the pyrolusite (Mn0₂), needed to begin a new round of the process. Ilene, the first reaction at 250+C produces hydrogen, while the second produces oxygen as follows:

4NaOH+2Mn0₂+talcum 250 C+25 C 2Na₂Mn0₄+talcum (1)

2Na₂Mn0₄+2H₂0+talcum 4NaOH+2Mn0₂+O₂+talcum

Since the required temperature of 250+C (to fuse the NaOH) is relatively low, the reaction (1) can be conducted with sunlight as shown on FIG. 5. There, a cylindrical mirror in the shape of half silvered and inflated transparent plastic (or of similar material) cylinder; where its transparent side faces the sunlight. Along the axes of the cylinder is afixed, the heat resistant, transparent tube, made from quartz, Pyrex, or of any other preferred material. It is initially filled up with the necessary mixture of 4NaOH and 2Mn0₂. The sunlight, concentrated by the said cylindrical mirror, raises the temperature of the mixture to the necessary amount and starts the above reaction (1), producing the desired hydrogen, which is then evacuated. It is important to keep the tube of reaction (1) out of air or oxygen, for otherwise instead of Hydrogen, water steam is obtained. To start reaction (2) the necessary quantity of water is introduced. Reaction (2) works, practically at any temperature, and the obtained oxygen is evacuated.

During night time or, on cloudy days, the reaction's tube should be removed from the cylindrical mirror, and be heated by the stored heat in granulated CaF₂, Calcium fluoride. The heat storage device, given on FIG. 5, is of the same construction as that of FIG. 5(b), the only difference being that when such device is used for storing heat, its tube should be filled up with CaF₂ in order to collect the heat from the available sunlight.

Derivation of Acetals and Hemi Acetals from Methane or Methane Hydrates, which can be found in the seas, like the Black Sea and the world's Oceans for the use as an alternative energy source in the production of mechanical work or thrust, and used as well by the Bezentropic Bladeless Turbine. The derivation of the acetals and hemi acetals from methane or methane hydrates take place in a reactor consisting of four sections, termed sections A, B, C and D., and works by catalytic partial oxidation in the presence of insufficient air or oxygen, performed in section A. There the used catalyst, 1, consists of 99.99% pure electrolytic copper. The required temperature is 440° C.±20° C. The necessary pressure is atmospheric, to no more than 40 atmospheres (if avoiding large reactors and constructions is preferred). The continuous catalytic partial oxidation yields a flow of intermediary synthesis blend of aldehydes, alcohols and negligent amount of ketons. The main amount there, in descending rates, is formaldehyde followed by acetaldehyde, methanol and some ethanol. When propane, butane or, preferably, the hydrocarbons from inventor's fuel alloys from a previous patent, are added to the feed stock, this increases the amounts of the acetaldehyde and the ethanol; propanal, buthanal, isopropyl and butyl alcohols appear in small amounts but, in general, the amounts of the aldehydes formed are twice those of the alcohols.

Since the catalytic oxidation is exothermic, section A of the reactor must be carefully cooled by circulating water inside a copper serpentine (made like the catalyst from 99.99% pure electrolytic copper) to keep the above required temperature interval of the reaction stable. The catalyst could be either of copper sponge or of spiral copper wire.

It is not necessary to separate the products of the catalytic oxidation, because such a mixture produces a bouquet of acetals, in that they perform better as fuel and as anti-knocks, than do the single acetals. The duration of the oxidation process lasts only about 0.4 seconds.

The thusly obtained bouquet of aldehydes and alcohols is then passed into the second section, B, of the reactor, using the second zeolite catalyst doped by CaCl₂. The blend, obtained from the partial oxidation, is then sprinkled with water, to absorb and cool down the aldehydes and alcohol blend down to about 50° C. Then, under the influence of the catalyst, the bouquet of the desired fuel acetals appears, dissolved in the water having boiling temperatures from 44° C. to 150° C.

Then, in order to have summer acetal fuel, the fraction between 44° C. and 89° C. is first distilled, while the rest is distilled as winter acetal fuel. The distillation proceeds in section C of the reactor, and then in a separate distiller, a second distillation is performed, because the formaldehyde intermediary feed stock contains around 60% water which cannot be eliminated by one distillation. Such a problem does not exist, when, instead of formaldehyde, acetaldehyde is used, since it does not contain water.

Given that section A, of the tubular chemical reactor produces twice as much aldehydes as alcohols, half of the obtained aldehyes stay unreacted. To avoid such a loss, half of them are passed inside section D of the chemical reactor, where they are hydrogenated to their corresponding alcohols, and then blended with the other half, inside section B, to be converted into additional acetal fuels.

Moreover, looking for clean fuel diversity, the inventor modified the Mobile Oil Process, which converts Methanol into light gasoline consisting mainly of Hexane. The said complete modification consists of replacing the methanol with the said unreacted extra aldehyde blend of the partial oxidation in the reactor, by passing that extra blend through the catalyst ZSM-5. A similar light gasoline is obtained consisting again mainly of hexane. The hexane however evolves more CO₂ plus some other small pollutants. It is of a lower octane number than the acetal fuels. However, given that Hexane is less polluting than the other forms of gasoline, it makes sense to use it for the manufacture of additional acetal fuels.

The chemical formulae of the Partial Catalytic Oxidation and of the Synthesis of Acetal Fuels are: the partial catalytic oxidation of methane yields: aldehydes, alcohols and some ketons (mainly acetone) or:

mCH₄+m/nO₂ 450 C±25 C 2p[HCHO]+p[CH₃CHO+C₂H₅OH]+Cu(99.99%)+p/q[R₁CHO+R₁OH+ketons] 1).

Similar reaction can be performed with any other hydrocarbon, even with crude oil, but are not preferable, since this introduces the carcinogenic cyclic hydrocarbons and dioxin formed during such fuel combustion.

The next formulae of the synthesis steps are related to the catalytic conversion of the above intermediary product to acetals. In order to achieve them, the vapor phase of the said intermediary products should be sprinkled with water to absorb the aldehydes and convert them to liquid phase, because the dry (gaseous) form aldehydes do no react with the alcohols. The said liquid phase is then blended with a powdered zeolite catalyst doped with CaCl₂ and passed to section B of the reactor. The following reactions produce first hemi (half) acetals, and then the desired acetals:

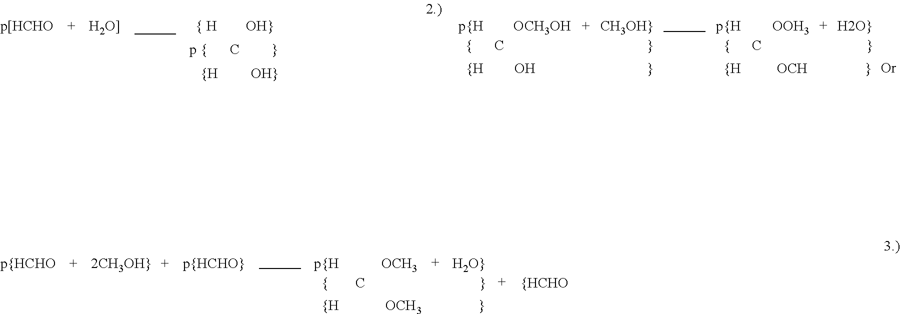

and by analogy

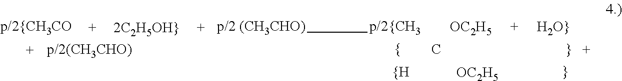

part of the above reaction yields as well mixed acetals as follows:

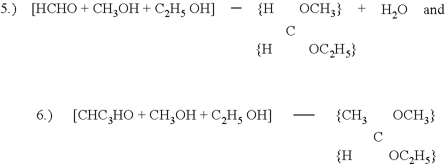

In the above conditions it becomes clear that the general formula of the hemi acetals is:

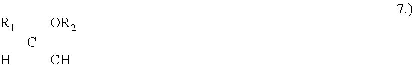

and that the generalized formula of the acetals is:

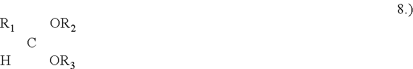

in the above conditions it becomes clear that the general formula for the hemi acetals is expressed by formula 7, while the general formula of the acetals is described by formula 8.

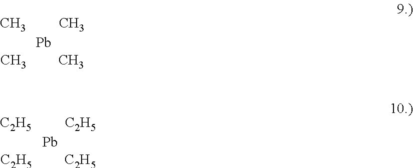

Examining first their structural formulae and properties, the inventor concluded that their high octane number (O.N.) of over 114, is not due to the lead atom, but rather, is due to the existing “4 valences property”, bounding 4 alkyl radicals. By replacing the Pb atom, with another atom, having 4 valences electrons, carbon C was selected for this purpose, in order to attach to it different radicals. This led to the formulae of the hemi Acetals and to the Acetals. The experimental tests performed first in the United States, then at the Plama Refinery, in Pleven, Bulgaria, indicated that the octane number of any acetal, ranging from an Octane number of 123 to 150.8 surpass those of the alkyl lead compound. Road tests conducted both in the United States and in Bulgaria have shown that they make the best antiknocks, with the exception of hydrogen. The same road test further indicated that when to the acetal fuels, 4% to 8% water is added, the water dissolves them, cooling the car's engine internally, through its latent heat of vaporization, thereby yielding up to 15% more mileage. As such they can be used as an alternative source of fuel for the start up engine for the Bezentropic Bladeless Turbine, or for thrust

What I claim is:

1. A new use of the process of stimulated rectification of the kinetically disordered molecules of gas, steam, and as desired a combination of both, which mono-directional molecular order is maintained and sustained, and used as such as the working body for the production of mechanical work as desired for thrust, attained when the aforementioned kinetically disordered molecules are introduced into the converging end of selected appropriate nozzles, whereby their flow of jet stream emitted by the diverging end of the preferred nozzles, becomes rectified into mono-directional molecular order, which molecular order is when maintained and sustained, and is thus directly employed, in its rectified state, as the working body to produce mechanical work, as well as when desired, to produce thrust.

2. Is limited to the oval (flattened) modification of the nozzle of Laval, which ensures the same process of claim 1, characterized by the following components: both the convergent and divergent portions of the nozzle of Laval are flattened in order to accommodate, thereby leading to a better fit, the shape of the spiral channels of the Bezentropic Bladeless Rotor, whereby a perforated dead end tube is added to the divergent section of the oval nozzle, whose role is to provide additional mass to the turbine's working body for desired additional mass.

3. The process of maintenance and sustenance of the kinetically rectified molecules of gas, steam, as well as a combination of both, emerging from the divergent end of the preferred nozzle, is attained through the injection of the said rectified molecules into the spiral channels of the bladeless rotor, which spiral channels maintain and sustain their molecularly rectified state, by providing a clear unimpeded path for the propagation of the said rectified molecules, thereby preventing the reversal into the disarray of the kinetically rectified and ordered mono-directional jet stream into kinetic molecular disorder, thus enabling and using the rectified molecular jet stream as such, directly, as a working body to produce mechanical work as well as thrust.

4. The Bezentropic bladeless rotor, which rotor possessed of a shaft, housed inside a bladeless stator, and where the preferred type and selected number of metal spirals, of selected width, are attached in opposition around the shaft of the rotor, then wound in opposing involute spirals, coiled and inserted between the left and right disks, and wound around the shaft, whereby the spirals are attached to the periphery of the disks forming the spiral channels that characterize the Bezentropic Bladeless Rotor, and housed inside the empty stator, where a choice of aforementioned nozzles are attached whose rectified, mono-directional molecular jet stream emitted from the divergent end of the nozzles, is blown inside the rotor's spiral channels, forming rectified molecular coliner, cyclic, circular (vortex) order, which is maintained and sustained, and used as such to produce mechanical work and when desired thrust, whereby a series of apertures made on the left and right covers of the Bezentropic turbine rotor and stator, located around the shaft, from where the combusted and used gas is exhausted and suitably removed, for other needs, like co-generation, using known methods and devices.

5. Is limited to the spiral channels formed by the space between the selected alloy sheet metal spirals, attached at either end to the left and right disks and wound in involute opposing spirals around the shaft of the Bezentropic Bladeless Rotor of claim 4, which form unimpeded pathways, through which the molecularly rectified mono-directional jet stream of the preferred gas, steam, as well as a combination of both, when emerging from the divergent end of the preferred nozzles is injected and blown into the spiral channels' pathways, thereby maintaining and sustaining their rectified, mono-directional trajectory, resulting in and forming an extension of the divergent end of the preferred nozzles, which are attached to the bladeless stator and thereby connected to the bladeless rotor of claim 4, all the while maintaining their efficiency and efficacy, whereby these spiral channels transform the preferred nozzles into a Bezentropic bladeless turbine.

6. Is limited to the Bladeless Stator, a cylindrically shaped empty device with apertures, serving to house the Bezentropic Bladeless Rotor of claim 4, comprising of selected number of air ducts, equal to the number of combustion chambers and the use of suitable nozzles, upon which the nozzles are attached, with the apertures used to collect the spent working body of gas, steam, as well as, a combination of both, for co-generating purposes.

7. The Bezentropic Bladeless Turbine is a device that employs the process of molecular rectification of claim 1, emitted by a choice of nozzles of the preceding claims, and the process of maintaining and sustaining the rectified molecular order of claim 3, using it as its working body for the production of mechanical work, the Bezentropic Bladeless Rotor of claim 4, and further comprising of the following elements:
a) a cylindrically shaped bladeless empty stator housing the bladeless rotor, possess of a selected number of wide tubular air ducts, equal to the number of combustion chambers and of suitable nozzles used, upon which apertures the nozzles arc attached;
b) a bladeless rotor, whose role is to capture the injected kinetically rectified co-linear jet stream of gas, steam, likewise their combination, emitted into its spiral channels from the suitable nozzles, then to maintain it and sustain it, using it as its working body to produce mechanical work;
c) suitable combustion chambers, possessed of classic spark plugs, plus a common ignition system required for all gas turbines;
d) a number of fuel delivery systems equal to the number of combustion chambers,
e) a suitable compressor with a starting engine;
a suitable generator for the production of electrical power.

8. The Bezentropic Turbo Compressor is essentially made up of the same elements as those claimed in the Bezentropic Bladeless Rotor of claim 4, comprising essentially of a cylindrical shaped bladeless, empty stator, designed to house the bladeless rotor of the Bezentropic Turbo Compressor, whose diameter is larger than that of the Bezentropic Bladeless Rotor used in the Bezentropic Turbine of claim 7, whose role is to provide the appropriate air at the desired pressure to the combustion chambers and comprising of the following elements:
a) the Bezentropic Turbo Compressor has two or more alloy sheet metal spirals, of selected width, welded in opposition around the shaft of the bladeless rotor, wound in opposing involute spirals, coiled and inserted between the left and right metal disks, forming with the shaft a reel, at which disks, the coils are welded as well, up through to the periphery of the disks, forming two opposing ‘spiral air ducts’ which suck in air when the rotor is rotated, for which both disks have near and around the shaft a series of suitable apertures,
b) the right and left cover of the stator have a series of apertures, aerodynamically designed, to enable both the suction and the injection of compressed air into the suitable combustion chambers,
c) two or more wide tubular air ducts, equal to the number of the used combustion chambers, welded upon the special apertures upon the cylindrical stator's periphery with the other ends of the said tubular air ducts being connected to the combustion chambers,
d) Laval nozzle or any other preferred nozzle, equaling the number of combustion chambers attached to the compressor whose the task here is to increase the dynamic pressure, and thus to act as a check valves for the combustion chambers,
e) a starting engine.

9. The Bezentropic Universal Steam Turbine, which uses the process of molecular rectification of claim 1, the maintenance and sustenance of the kinetically rectified molecules of gas, steam, as well as a combination of both, of claim 3 with the Bezentropic Bladeless Rotor of claim 4, essentially comprises a steam generator, connected to a choice of suitable nozzles attached to a Bezentropic Bladeless Rotor of the aforementioned claims, which is housed inside the bladeless stator, with suitable apertures created around the shaft for recovery of the spent working body, whereby the suitable steam generator replaces the compressor and combustion chambers, injecting the steam into the preferred nozzles, with the emitted molecularly rectified jet stream enters the spiral channels of the Bezentropic Bladeless Rotor producing mechanical work, which in turn can be attached to a suitable generator for the production of electricity.

10. The Bezentropic Wind Turbine, which uses the molecular rectification process of claim 1, preferred nozzles, the maintenance and sustenance of the kinetically rectified gas molecules, of claim 3, with the Bezentropic Bladeless Rotor of claim 4, essentially comprising the following: open, sac-like vessel elevated to a preferred height, and twisted as needed to capture the wind currents, possessed of a long tube, through which the captured the wind current is being blown down the tube and is connected to the Bezentropic Bladeless Rotor housed inside its empty stator, which in turn is connected to a generator of choice, thus creating a wind powered plant for the production of electricity.

11. The Bezentropic Hydraulic Freon Steam Turbine, uses the same process of molecular rectification of claim 1, the process of sustenance and maintenance of claim 3, with the Bezentropic Bladeless Rotor of claim 4, further comprising an elevated closed circuit tubular system, which capture the safety Freon, which as it boils and evaporates at ambient temperatures, rising up the tubular system, condenses, and is collected by a receiving cooler, then precipitates, descending down the tube, whereby, the evaporation process creates latent heat of vaporization, which is then converted into potential energy, with the ensuing condensation collected on site by a receiving cooler, once again initiates precipitation, forming the Freon falls, where the potential energy is transformed into kinetic energy that is produced as a result of the precipitation, which is then fed via a tube to the Bezentropic Bladeless Rotor forming the bladeless turbine that is mounted at ground level and attached to a generator, whereby the exhausted liquid Freon is directed back to the Freon heater, via a pump, in order to resume a new round of evaporation, condensation and precipitation, with the Bezentropic Hydraulic Freon Turbine comprising essentially of:
a) a Freon heater with a heating element comprising a serpentine for using the ambient air temperatures of the summer months,
b) a vortex tube which separates the air molecules into hot and cold flow, with the hot flows being blown into the Freon boiler generating the Freon Steam,
c) a tubular elevation for the Freon steam which ranges in height from 100 to 200 meters creating potential energy generated from the Freon steam's latent heat of vaporization,
d) a cooler, employing the cold end of the vortex tube, which condenses the evaporating Freon, whereby the potential energy is spontaneously converted into kinetic energy as the Freon precipitates down the tube,
e) which in turn at ground level this kinetic energy is used to rotate the Bezentropic Bladeless Turbine, as well as its steam variation, with the closed circuit system having the following elements,
f) a suitable compressor required for the needs of the vortex tube,
g) a pump for pumping the exhausted liquid Freon used by the Bezentropic Bladeless turbine back to the serpentine, along for continuous evaporation of the Freon to support its continuous operation.

12. Is limited to the use of a suitable gas, steam, its combination, as well as of a liquid, employed in a closed circuit tubular system, which lends itself to evaporation, condensation and precipitation using the Bezentropic Bladeless Rotor of claim 4, and the process of claims 1 and 3, which when attached to a suitable generator is used for the production of electricity.

13. The Bezentropic Bladeless Turbo Compressor of claim 6, essentially comprised without the addition of nozzles.

14. Essentially comprises a Bezentropic Bladeless Turbine using the Processes of claim 1 and claim 3, and the Bezentropic Bladeless Rotor of claim 4, employing a choice of compressor and fuel chambers in order to produce thrust.

15. Essentially comprises a Bezentropic Bladeless Turbine, using the processes of claims 1 and 3, and is limited to the use of safety or quiet Hydrogen to power its Bezentropic Rotor of claim 4 in order to produce mechanical work or thrust.

16. Safety (quiet) Hydrogen used as an energy source is essentially comprises a treble plurality (set) of steps, the first one consisting of a redox (reducing+oxidation), obtained by modifying the reaction yielding sodium manganate Na₂Mn0₄, when it in the absence of air and adding Talk (hydrated Magnesium Silicate) 3MgO.4Si0₂.H₂0, facilitates the ensuing Hydrolysis of the thusly obtained rocky Sodium Manganate, whereby the hydrolysis reverts back to the initial reactants, sodium hydroxide (NaOH) and the pyrolusite (Mn0₂), necessary for starting a new round of the reaction; as such, where the first reaction at 250+C produces Hydrogen, while the second produces Oxygen:
4NaOH+2Mn0₂+talcum 250 C+25 C 2Na2Mn0₄+talcum (1)
2Na₂Mn0₄+2H₂0+talcum 4NaOH+2Mn0₂+O₂+talcum (2)
since the required temperature of 250+C (to fuse the NaOH) is relatively low, reaction (1) can be conducted with energy produced by the sun using a cylindrical mirror in the shape of half slivered and inflated transparent plastic cylinder; where its transparency faces the sunlight, along the axes of the cylinder is affixed, the heat resistant, transparent tube made from quartz, as well as Pyrex-like material, which initially is filled with the necessary mixture of NaOH and Mn0₂, whereby the sunlight, concentrated by the said cylindrical mirror, raises the temperature of the mixture to the necessary degree, starting the above reaction (1), producing the desired hydrogen, then evacuating it, where inside the tube of reaction (1) it must be kept out of air or oxygen, as otherwise water steam would be obtained, whereby. starting reaction (2) the introduction of the necessary quantity of water should be carried out, which reactions works, practically at any temperature, with the obtained oxygen is then evacuated through a tube, whereas, carrying out the reactions during night time or, on cloudy days, the tube containing the chemical reaction should be taken out of the cylindrical mirror, and be heated by the stored ‘sun heat’ in granulated CaF₂, the Calcium fluoride should be filled up with CaF₂ in order to collect sunlight and then used to heat the tube containing the chemical reaction.

17. Is limited to the use of the non-pollutant acetal and hemi acetal fuel alloys as an energy source to power the Bezentropic Bladeless Rotor of claim 4, and the processes of claims 1 and 3 to produce mechanical work as well as thrust

18. The non-pollutant acetals and hemi acetals possessed of an extremely high octane number, are essentially created by the following reactions: 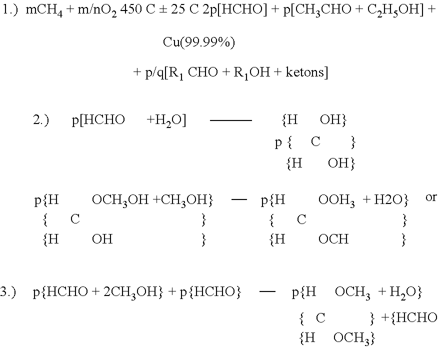
and by analogy 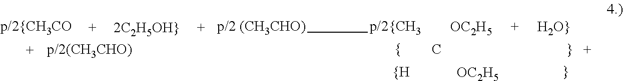
part of the above reaction yields as well mixed acetals as follows: 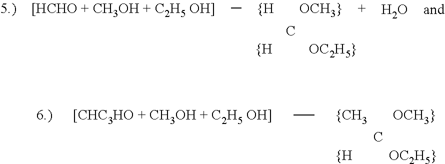
in the above conditions it becomes clear that the general formula of the hemi acetals is: 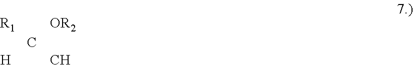
and that the generalized formula of the acetals is: [chemical structure]
